(19) United States
(12) Patent Application Publication
(10) Pub. No.: US 2012/0160753 A1
(43) Pub. Date: Jun. 28, 2012

(54) WATER DESALINATION PLANT AND SYSTEM FOR THE PRODUCTION OF PURE WATER AND SALT

(76) Inventors: Nishith Vora, Bensalem, PA (US); Irving David Elyanow, Lexington, MA (US); Robert Lee Solomon, Seattle, WA (US); John Herbert, Marlborough, MA (US); Lanny D. Weimer, Ellicott City, MD (US)

(21) Appl. No.: 13/297,756

(22) Filed: Nov. 16, 2011

Related U.S. Application Data
(63) Continuation-in-part of application No. 12/345,856, filed on Dec. 30, 2008.

(51) Int. Cl. C02F 9/10; C02F 1/58; C02F 1/52; B01D 61/08; C02F 1/44; C02F 9/04

(52) U.S. Cl. 210/175; 210/252; 210/202; 210/195.2; 210/258

(57) ABSTRACT

A desalination plant for treating a sea water or brackish water feed is provided. The desalination plant includes a first treatment section to effectively remove scaling species, the first treatment section including nanofiltration section, the nanofiltration section including at least two stages and at least two passes; and a reverse osmosis section that operates at high recovery to produce a purified permeate stream and a selectively NaCl salt-enriched reject stream as a saline output.

### CROSS REFERENCE TO RELATED APPLICATIONS

This application is a continuation-in-part (CIP) of U.S. patent application Ser. No. 12/345,856, filed on Dec. 30, 2008, which is incorporated herein by reference in its entirety.

### BACKGROUND OF THE INVENTION

1. Field of the Invention

This present disclosure relates generally to desalination, salt production, and water production. In particular, it relates to a process for converting seawater to potable water.

2. Description of Related Art

For centuries, common salt has been produced by evaporative concentration of seawater or of another naturally occurring brine, typically by using open-air evaporation lagoons or thermal concentration equipment and processes. A number of modern industrial processes require salt of substantially high purity, such as a sodium chloride salt substantially free of undesirable chemical or taste components. Such high purity salt may be mined from some natural geological formations, and may also be obtained from other saline waters by concentration and treatment steps that remove the principal unwanted impurities present in a starting solution.

Potable, high-quality or pure water has also historically been produced, when fresh water is not available, from natural saline or brackish waters, originally by thermal processes such as freezing or distillation, and more recently by membrane processes such as reverse osmosis or membrane vapor permeation, and/or by hybrid membrane/thermal processes. When starting with a saline feed, all of these water production processes recover or purify only a fraction of the water present in the feed, and generally produce waste brine that is substantially more concentrated than the original feed stream.

Two processes, production of salt and production of pure water, may each start with a seawater or brackish water feed, and some proposals have been made for a unified co-production of the two commodities, particularly in circumstances when an additional economic benefit can be readily derived from the second product, or where environmental considerations regarding water reclamation or solids management dominate. However, water is perhaps the least valuable commodity, and when sitting a water plant where there is a need for water and a supply of feed water is available, much engineering skill goes into arranging the water treatment to minimize capital and operating cost, i.e., to maximize water production for the total project or to minimize capital and/or operating treatment costs per unit of water produced.

Processes for producing water treat, remove, or concentrate different solids with varied effect. Salt plants, by contrast, produce a more valuable commodity, typically in a lower quantity, often by removing a vast quantity of the original solute. Salt manufacturers may employ different separation or refining processes that may be antagonistic toward or poorly compatible with the mechanisms or production goals of water treatment. There have been proposals to combine and optimize water and salt co-production, although a number of these proposals have been driven by a specific environmental task (such as mine drainage cleanup), have taken advantage of a natural opportunity (such as presence of a fairly pure saline ground water), or have been driven by a high-level conceptual goal, (such as complete elimination of a liquid effluent (ZLD), extraction of a subsidiary value, or achieving better control of a specific waste output). While such specific or top-down system proposals may in concept answer certain needs, they fall short of providing a general seawater water and salt process. A better approach would employ rigorously reasoned analysis to integrate a system in light of competing considerations of costs, efficiency, energy consumption, water recovery, or other factors. However, there are great variations in local conditions, as well as a variety of treatment equipment and materials available for effecting treatment, and the range of equipment spans different areas of expertise. A limited amount of theoretical or modeling tools exist for predicting the operation or effectiveness of non-standard systems, such as selective filtration at high mixed solids loading, and modeling of such systems is a time-consuming and complex undertaking. Applicant is not aware of existing commercial-scale plants capable of efficiently producing both a high quality salt output and a pure water output from a common sea water or substantially impure brackish feed.

Several factors contribute to this state of affairs. Water is a cheap commodity, yet the equipment used in the production of pure water from a brackish or saline feed requires a large capital investment and operation of the plant requires large inputs of energy. The design of a plant to operate in a stable, economical, and physically predictable manner under a particular set of conditions is a complex engineering problem. Production of salt involves at least one brine stream of high concentration, but high concentrations generally introduce scaling and corrosion problems, particularly in high flux, high temperature, or multi-conduit treatment equipment, and are thus generally considered outside the conservative range of input parameters employed in modeling high production water systems. To design a water production system and also purify the process waste streams to produce salt may be desirable from grand perspective, e.g., as a zero-liquid discharge (ZLD) process, but the engineering implementation requires a conceptual shift from the water-based on the permeate to the necessarily-produced but not optimized brine streams, possibly requiring extensive piloting of new purification approaches applied to concentrated saline intermediate streams.

One problem is that sea water and other natural saline waters contain many solutes and impurities, so the salt-enriched side streams of a pure water production process—the concentrated reject of a reverse osmosis water treatment, or the residue of a distillation process—include other solids that both limit flux or treatment rate and/or recovery of the water side and must be removed on the brine side if a high quality salt is desired. These dissolved solids can be corrosive and scale forming, the underlying de-watering processes consume great amounts of energy, and the concentrated salt mixtures require purification. Moreover, the intended scale of production strongly governs capital cost and the size of waste streams. Seawater reverse osmosis (RO) plants operating at 40-50% recovery generate 1 to 1½ units of concentrated brine waste for each unit of permeate, so the intake pumps, clear wells and pretreatment must be oversize. Seawater salt production plants must remove water that constitutes over 90-95% of the input mass, for which evaporation lagoons appear to offer the least expensive, albeit slow, treatment approach, while energetic processes become quite costly.

A number of related and possibly suggestive first steps have been taken toward membrane-based integrated water and salt production. Some systems are identified in the articles by Marian Turek entitled Seawater Desalination and Salt Production in Hybrid Membrane-Thermal Process (Desalination 153 (2002) 173-177) and Marian Turek and Maciej Gonet entitled Nanofiltration in the Utilization of Coal Mine Brines (Desalination 108 (1996) 171-177). The earlier of these papers deals with remediation of a coal mine water with a high quality sodium chloride brine, the water desalted by thermal crystallization processes. The later paper built on the earlier experience to explore the economics of combined systems employing nanofiltration pretreatment to increase the achievable water recovery of combined systems of less pure brackish waters. The economics of such systems depend strongly on the local cost of energy. Optimization of such approaches, as applied to more concentrated natural brines, such as sea water, require development of appropriate techniques for economically and dependably refining the concentrated but mixed brine streams produced in the water production lines, and also development of appropriate modeling and solution of optimization and prediction algorithms for the system as a whole to operate effectively. On the water production side, it is known in the art that seawater is treated by a one- or two-stage nanofiltration process during the production of water for potable or agricultural use. Certain nanofiltration or desulfation membranes, with or without later reverse osmosis, have been used for decades to condition sea water so that it may be used for sulfate-free non-scaling down hole injection water in oilfield production applications or with more complete demineralization treatment for applications such as boiler, cooler or thermal distillation feed.

In addition, there have been studies aimed at modeling water systems incorporated in cogeneration plants to assess cost and efficiency of water production with hybrid approaches, such as multistage flash/reverse osmosis. One such study accounts for energy costs, carbon credits and other inputs. Thus, a number of parameters relevant to evaluating water production systems have been explored, sometimes with a view to increase the perceived value of the system (e.g., carbon credits) to justify the greater cost of addressing a dual water/salt production problem. In addition, with the invention of effective nanofiltration membranes, it has been proposed to purify concentrated salt solutions by nanofiltration as one stage in a salt extraction process. UK Patent GB2395946 has proposed in general terms a hybrid membrane/thermal plant for co-production of water and salt. To applicant's knowledge, this proposal does not appear to have resulted in a working plant.

Although a salt or a water production plant is historically most likely to be specially engineered for a specific owner, such as a municipality (for water) or a hydrocarbon-, polymer- or food processor (for salt or chlorite), larger industrial platforms are being designed from the ground up around the world, making it worthwhile to deeply explore possible efficiencies of integration.

A real and substantial need exists to produce pure water suitable for municipal supplies, for power, boiler, or other industrial uses, or for agricultural use, and these needs may exist in the same region, or the same site, where a high purity brine or salt product is needed for food or chemical production.

### BRIEF SUMMARY OF THE INVENTION

In one embodiment of the present invention, a desalination plant for treating a sea water or brackish water feed is provided. The desalination plant includes a first treatment section to effectively remove scaling species, the first treatment section including nanofiltration section, the nanofiltration section including at least two stages and at least two passes; and a reverse osmosis section that operates at high recovery to produce a purified permeate stream and a selectively NaCl salt-enriched reject stream as a saline output.

In another embodiment of the present invention, a desalination plant for treating a seawater or brackish feed including a nanofiltration section and a reverse osmosis section is provided. The nanofiltration section includes at least two stages and at least two passes, wherein the nanofiltration section is arranged to form a nanofiltration permeate substantially diminished in scaling and fouling components, and wherein the nanofiltration permeate is fed to the reverse osmosis section.

In yet another embodiment of the present invention, a water desalination system is provided. The water desalination system includes an intake section of a size to supply and pretreat a defined flow of a seawater or brackish feed containing sulfate for a system having a pure water output capacity; a nanofiltration section configured to filter the defined flow to produce nanofiltration permeate at recovery above from about 70% to about 80% and configured to reduce sulfate concentration at least about 90%, the nanofiltration section including at least two stages and at least two passes; and a reverse osmosis section which receives the nanofiltration permeate as a feed and operates to produce a reverse osmosis permeate stream at a recovery above from about 70% to about 80% and a concentrated reverse osmosis reject stream suitable for enhanced commercial NaCl production, whereby the reverse osmosis permeate amounts to from about 49% to about 64% of the defined flow of the feed and the intake section is sized less than twice the pure water output capacity.

### BRIEF DESCRIPTION OF THE DRAWINGS

These and other aspects of the embodiments of the present invention will be understood from the description and claims herein, taken together with the drawings showing details of construction and illustrative embodiments, wherein:

FIG. 1 schematically illustrates a system for the integrated production of salt and water outputs in accordance with one embodiment of the present invention;

FIG. 2 schematically illustrates a system for the integrated production of salt and water outputs in accordance with one embodiment of the present invention;

FIG. 3 shows a process flow diagram with nanofiltration and reverse osmosis sections, indicating representative water qualities and recoveries or the different sections;

FIG. 4 illustrates details of a brine concentrator for the salt production section in accordance with one embodiment of the present invention;

FIG. 5 schematically illustrates a system for the integrated production of salt and water outputs in accordance with one embodiment of the present invention.

### DETAILED DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

The singular forms “a,” “an” and “the” include plural referents unless the context clearly dictates otherwise.

An integrated plant for the production of both pure water and a salt or slurry product, operable at a large industrial capacity to effectively provide water at high recovery and salt of high purity with greatly enhanced efficiency is disclosed.

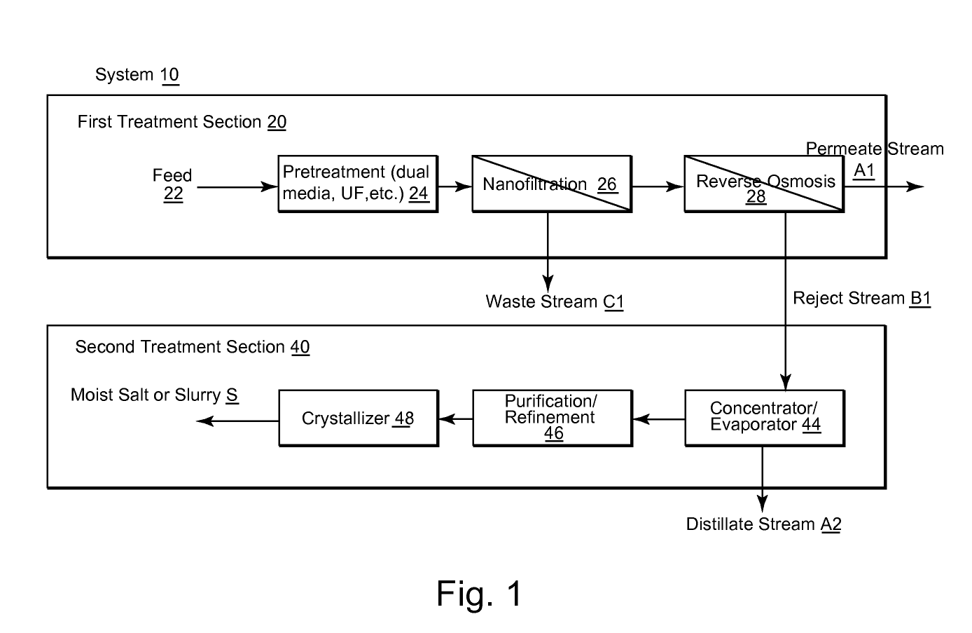

Disclosed is a desalination plant that operates with a sea water or brackish water feed 22 and produces a concentrated and selectively improved salt reject stream B1 and a pure water permeate stream A1 from a first treatment section 20 that is arranged to produce primarily water at high recovery using membrane desalination processes. The first treatment section 20 may also be referred to as a first processing section or first treatment line. The reject stream B1 from the first treatment section 20 has a component distribution that is substantially reduced in native di- and polyvalent scaling ions, essentially depleted of sulfate, has substantially higher total dissolved solids (TDS) than a traditional sea water reverse osmosis (SWRO) reject, yet is suitable for thermal treatment processes. The system may be enhanced by monovalent salt components. The first treatment section 20 may be built as a stand-alone unit which, for a given output capacity, advantageously requires relatively undersized intake and pretreatment components and produces high quality permeate at high recovery. In one embodiment, as illustrated in FIG. 1, the first treatment section 20 may be integrated with a second treatment section 40, in which the reject stream B1 is further concentrated, purified, and processed to produce a high purity salt product.

In one embodiment, a desalination plant for treating a sea water or brackish water feed 22 is disclosed wherein the desalination plant is comprised of a first treatment section 20 to effectively remove scaling species, the first treatment section 20 comprising a reverse osmosis section 28 that operates at high recovery to produce a purified permeate stream A1 and a selectively NaCl salt-enriched reject stream B1 as a saline output for processing into bulk salt. In one embodiment, the reject stream may be concentrated to above about 85,000 ppm total dissolved solids (TDS).

The first treatment section 20 may produce a purified permeate stream via membrane pressure filtration processes at recovery above about 55% and removes a preponderance of species that contaminate salt production. The pressure membrane filtration processes may include nanofiltration softening which effectively removes substantially all sulfates. Alternatively, the first treatment section 20 is comprised of a multistage/multi-pass nanofiltration section 26 such that bivalent ions are substantially removed from nanofiltration permeate, while operating at a recovery level above about 65% to form a monovalent salt enhanced permeate stream for concentration.

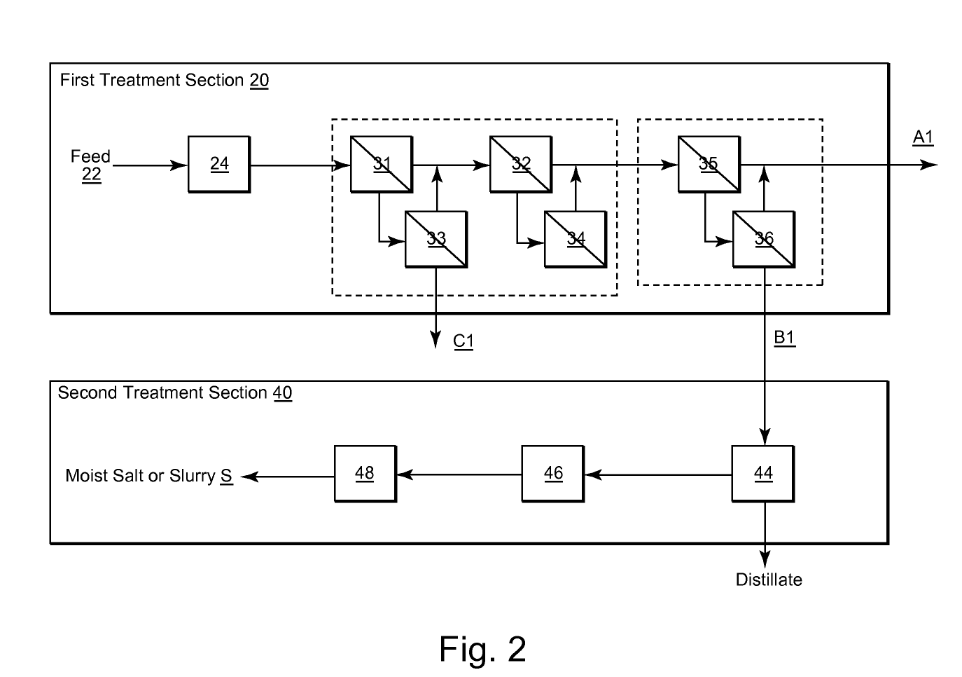

As illustrated in FIG. 2, in one embodiment, the first treatment section 20 is comprised of a multistage/multi-pass nanofiltration section 26. In the illustrated embodiment, the multistage/multi-pass nanofiltration section 26 comprises multiple nanofiltration units 31, 32, 33, 34. While four nanofiltration units are illustrated in the exemplary embodiment, it is contemplated that the nanofiltration section 26 may comprise more or fewer nanofiltration units. As used herein throughout the specification and claims, a nanofiltration pass comprises at least one nanofiltration unit, wherein the permeate stream of the nanofiltration unit is passed to the next section of the first treatment section 20. In a multi-pass nanofiltration section, the permeate stream of a first of an at least two nanofiltration units is passed to a subsequent nanofiltration unit of the at least two nanofiltration units, until the permeate of a final stage of the multi-pass nanofiltration section is passed to the next section of the first treatment section 20.

As used herein throughout the specification and claims, a nanofiltration stage comprises at least one nanofiltration unit, wherein the concentrate stream of the nanofiltration unit is subjected to further processing in the nanofiltration section 26. In a multistage nanofiltration section, the concentrate stream of a first of an at least two nanofiltration units is passed to a second of the at least two nanofiltration units, where the concentrate stream is again processed to yield a second concentrate stream and a second permeate stream. The second permate stream is passed to the next section of the first treatment section 20, while the second concentrate stream is either removed with a nanofiltration waste stream C1 or is returned to a front-end stream of the nanofiltration section 26. In a multistage/multi-pass nanofiltration section, the second permeate stream is passed to a subsequent nanofiltration stage.

FIG. 2 also illustrates an embodiment that includes a multistage reverse osmosis section 28. In the illustrated embodiment, the multistage reverse osmosis section 28 comprises multiple reverse osmosis units 35, 36. While two reverse osmosis units are illustrated in the exemplary embodiment, it is contemplated that the reverse osmosis section 28 may comprise more or fewer reverse osmosis units Similar to the discussion relating to a nanofiltration stage above, as used herein throughout the specification and claims, a reverse osmosis stage comprises at least one reverse osmosis unit, wherein the concentrate stream of the reverse osmosis unit is subjected to further processing in the reverse osmosis section 28. In a multistage reverse osmosis section, the concentrate stream of a first of an at least two reverse osmosis units is passed to a second of the at least two reverse osmosis units, where the concentrate stream is again processed to yield a second concentrate stream and a second permeate stream. As is illustrated in FIG. 2, the second permeate stream may be combined with the permeate of the first of the at least two reverse osmosis units to form a purified water permeate stream A1. The second concentrate stream may be removed from the first treatment section 20 as the concentrated and selectively improved salt reject stream B1.

In one embodiment, the pure water production stage, and the selective salt or sodium chloride enrichment are performed by passing a sea water or brackish feed 22 stream through a pretreatment section 24 (coarse screen, media filter, flocculation and clarification, ultrafiltration and/or other pretreatment process), to remove suspended solids and a substantial portion of organic matter, followed by nanofiltration. The nanofiltration effects a substantial reduction in sulfate (e.g., above about 95% and preferably above about 98%), removes bivalent ions while at least somewhat selectively passing monovalents. The initial nanofiltration operates at a relatively low feed pressure, and may include several stages and/or several passes, so that the nanofiltration permeate represents from about 70% to about 80% or more of the feed volume, achieving high water recovery. This nanofiltration permeate forms an intermediate permeate stream that is substantially free of scaling sulfate, relatively depleted of bivalent ions, and rich in monovalent salts, primarily NaCl, with a TDS that is about ⅔ that of the feed.

In accordance with another embodiment, this intermediate permeate may then be fed into a brackish water reverse osmosis (RO), seawater reverse osmosis (SWRO), or other reverse osmosis filtration system. Nanofiltration (NF) allows the reverse osmosis section 28 to operate on this permeate at high recovery without scaling and with very little need for antiscalant, to produce a pure water output and a substantially concentrated reject stream. By way of example, a two-stage nanofiltration section 26 may operate at from about 70% to about 80% recovery and the reverse osmosis section 28 may include a third stage high pressure brine recovery stage to operate at from about 70% to about 80% or more recovery on this nanofiltration permeate, giving an overall recovery of from about 50% to about 70% or more in the first treatment section 20. Higher recoveries are possible from certain brackish feeds. The reject stream B1 from the reverse osmosis section 28 contains greatly concentrated and improved quality sodium chloride, substantially free of sulfate and greatly depleted in magnesium and calcium, with a manageable concentration of potassium and other minor components. Compared to the seawater feed 22, from about 75% to about 90% or more of the original water component has been removed, and the stream may be concentrated to above 85,000 ppm TDS, substantially over the level of a conventional SWRO brine and above the feed 22 to a conventional salt production process, so that relatively little energy is required to bring this reject stream to saturation and produce the final salt output.

In embodiments comprising a second treatment section 40, the second treatment section 40 further concentrates the reject stream B1, and chemically precipitates unwanted impurities from the reject stream and forms a refined concentrate stream, such that salt may be continuously recovered by crystallization at purity above about 99% as a high purity salt product. While the second treatment section 40 may include or consist of one or more conventional salt production stages such as evaporation lagoons and precipitation ponds, in one embodiment, the second treatment section 40 may employ a thermal or hybrid process to concentrate the reject stream B1 from the first treatment section 20 while also producing one or more additional pure water or distillate streams A2, thereby further raising overall water recovery. Such additional pure water stream or streams may be of a different grade than the primary bulk water recovery of the first treatment section 20, and when two such streams are produced, each may be of a different quality, so that depending on local industrial, domestic or agricultural needs, the purified water streams may be blended or supplied separately to different classes of industrial and domestic users. In either case, the salt production and additional distillation quality water are produced from the same original stream, e.g., the reject stream B1 from the first treatment section 20, and thus any augmentation of the front end pretreatment capital equipment is not required.

In one embodiment, the second treatment section 40 is configured to concentrate and refine the reject stream B1, wherein the second treatment section 40 concentrates the reject stream B1 by a thermal or hybrid section and produces pure water and a purified salt product while operating above about 62% water recovery. In an alternate embodiment, the overall recovery may be above from about 65% to about 70%.

In one embodiment, the second treatment section comprises a concentrator/evaporator 44, a purification or refining section 46 and a crystallizer/salt output section 48. The concentrator/evaporator 44 may comprise a thermal or steam driven evaporator, a mechanical vapor compressor, a low-pressure evaporative concentrator, a brine concentrator or any other known thermal concentration and mechanical vapor recompression evaporator.

The concentrated salt stream produced in the thermal treatment line of the second treatment section 40 is then purified, e.g., by softening, such as with sodium hydroxide, to remove remaining magnesium and polyvalent metals such as iron, with sodium carbonate to precipitate calcium, and/or other chemical combinations to precipitate the residual metal and impurity ions so that the resultant salt product meets an intended purity standard (e.g., NaCl purity level and absence of critical contaminants) for chlor-alkali or other user applications. The concentrated and further purified stream passes to a crystallizer 48 and a pure salt product is crystallized. The high purity salt may be extracted as a moist solid or as a salt slurry from an evaporator/centrifuge loop in which the stream temperature may be easily controlled, e.g. with mechanical vapor recompression, to provide supersaturated salt solution and optimize sodium chloride crystallization.

In one embodiment, the second treatment section 40 removes residual impurities by chemical precipitation to produce a refined salt concentrate, and pure salt is separated at a temperature or further concentration effective to crystallize salt from a saturated solution. Crystallization may be driven by crystal seeding, allowing efficient and continuous take-off of the salt output from a precipitation and centrifugation loop, and both the crystallization and the purity of the product may be enhanced by allowing a small periodic blowdown from the loop to keep remaining unwanted species, such as potassium, below saturation in the crystallizer 48, and below a level that might impair crystallization or product quality. For this, a purge under about 1% of the initial brine feed volume or 3% of the crystallizer volume suffices, resulting in a near zero-liquid discharge (ZLD) process for producing a highly purified NaCl product. In one embodiment, the second treatment section 40 purifies and then crystallizes salt, maintaining low impurities in the crystallizer by periodic purge to remove interfering contaminants not removed by nanofiltration. In another embodiment, the refined salt concentrate forms a moist salt or slurry that is centrifugally extracted from a crystallizer seed loop and a crystal seed stream is returned from a centrifuge to a crystallizer liquor to drive crystallization for continuous take-off of the concentrated salt product. Advantageously, the concentrator/evaporator 44 may each produce additional output streams of pure water, increasing overall water recovery such that 100% of the reverse osmosis output (e.g., the permeate and the brine) of the first treatment section 20 is utilized. In one embodiment, periodic or continuous blowdown from the crystallizer 48 may be used to limit the specific impurities from the crystallized product.

Further concentration of the reverse osmosis reject stream B1 may be by a concentrator/evaporator 44. A mechanical vapor compression unit may be used to enhance evaporative efficiency while recovering additional water in this stage. In one embodiment, the second treatment section 40 comprises a concentrator/evaporator 44 that produces additional pure water or distillate A2 while further concentrating the selectively salt-enriched reject stream. By way of example, from about 70% to about 90% or more of the water present in the reverse osmosis reject stream B1 that passes to the thermal concentration/salt production stage may be recovered as additional water, including distillate-quality water, in the course of making the purified salt product, increasing the overall water yield from the dual process line. Much of the liquid waste generated in both sections, such as the nanofiltration waste stream C1, the relatively small amounts of water from pretreatment backflushes, salt crystallizer blowdown, and other processes, may be passed into a municipal waste stream or digestion process, be diluted with clarified effluent, or otherwise be harmlessly treated or discharged. Alternatively, a concentrator/evaporator 44 and crystallizer 48 may be used, such as in connection with cogeneration schemes, if low-cost or excess steam is available.

The selection of membranes for removal of multivalent ions up front, which may be accomplished using one or more stages, and/or one or more passes, of suitable nanofiltration membranes operating at a relatively low driving pressure, advantageously conditions the reverse osmosis feed (e.g., the nanofiltration permeate) such that the reverse osmosis may be driven at very high recovery with little or no anti-sealant, while ensuring the reverse osmosis reject stream B1 composition has a reduced need for downstream chemicals for the thermal treatment equipment or subsequent precipitation of residual impurities in the salt production section. The increased reverse osmosis recovery results in a substantially concentrated reverse osmosis reject stream B1, and thermal processes may be economically applied to a more concentrated salt feed with reduced scaling propensities and other advantages in the thermal salt purification processing. Nanofiltration provides a monovalent-enhanced feedwater to the reverse osmosis, more concentrated salt water to the salt concentration and purification section of the process, and reduces or eliminates requirements for membrane antiscalant treatment while allowing operation of the reverse osmosis section 28 at high recovery. The reverse osmosis section 28 in the first processing section may include an initial brackish water stage as well as one or more higher pressure SWRO stages, including, for example a brine recovery stage which operates at pressures of from about 80 atmospheres to about 100 atmospheres on an earlier stage reverse osmosis brine to simultaneously maximize reverse osmosis water production and elevate the TDS concentration of the reject without necessitating excessive pump energy or incurring a membrane scaling penalty.

In accordance with another embodiment, a potable water production line employing nanofiltration treatment may also be applied to reduce scaling components to such extent as to permit a moderate pH elevation of the reverse osmosis feed to be applied such that boron species present in the reverse osmosis feed are removed, and enable single stage or two-stage reverse osmosis to effectively remove remaining boron present in the feed. In one embodiment, boron is removed to a level below about 0.5 ppm. In another embodiment, boron is removed to a level below 0.3 ppm. The permeate from a high recovery seawater nanofiltration line may be treated to raise its pH above 8.3 ahead of a reverse osmosis line, to ionize boron species, and thus substantially remove boron and provide potable water. In one embodiment the nanofiltration line may be treated to raise the pH to between from about 8.3 and about 10.5. Such a system construction represents a substantial simplification in and advance in seawater-to-drinking water technology. Moreover, the substantial reduction in bicarbonate and buffering ions by nanofiltration allows a pH elevation to from about 8.3 and about 10.5 to be achieved with little caustic, and the system may be operated at higher pressure and high recovery without scaling.

In one embodiment, a desalination plant for treating a seawater or brackish feed 22 comprised of a nanofiltration section 26 and a reverse osmosis section 28 is disclosed, the nanofiltration section 26 arranged to form a nanofiltration permeate substantially diminished in scaling and fouling components, the permeate being fed to the reverse osmosis section 28. The reverse osmosis section 28 may be operated at high recovery to form a purified water permeate stream A1 and a non-scaling salt reject stream B1 concentrated above about 85,000 ppm TDS. The nanofiltration permeate may be fed to the reverse osmosis section 28 at an elevated pH to form a purified water permeate stream A1 having less than about 0.5 ppm boron. The pH of the nanofiltration permeate is raised ahead of the reverse osmosis section 28 and operates at a recovery of about 70% while producing a high recovery purified water permeate stream A1. In one embodiment, the pH elevation is from about 8.3 to about 10.5.

As schematically illustrated in FIG. 1, a system 10 in accordance with one embodiment of the present invention includes a first treatment section 20 and a second treatment section 40 in which salt is produced or in which both salt and water is produced. The first treatment section 20 may include, or may receive its feed from a pretreatment section 24 of known type and includes a nanofiltration section 26 and a reverse osmosis section 28, producing three output streams, namely a primary desalinated water reverse osmosis permeate stream A1, a primary reverse osmosis reject concentrated salt production stream B1 and a nanofiltration waste stream C1. The reverse osmosis section 28 of the first treatment section 20 may be a multistage reverse osmosis treatment section that operates at high recovery (about 70% or above) on the nanofiltration permeate, producing the principal product streams A1, B1 (water and salt concentrate) of the first treatment section 20. Thus, the first treatment section 20 includes membrane filtration units that produce the streams A1, B1. The nanofiltration waste stream C1 and other lesser waste streams such as pretreatment filter backwash and rinse waters may be passed to a municipal waste water treatment plant for utilization of its electrolytes and organics in waste digesters or for dilution with waste clarifier output streams before discharge.

As further shown in FIG. 1, the concentrated salt production stream B1 produced by the reverse osmosis section 28 passes to the second treatment section 40, which includes concentrator/evaporator 44, wherein the concentrator/evaporator 44 is a brine concentrator, a purification or refining section 46 and a crystallizer/salt output section 48. The concentrator/evaporator 44 raises the salinity of the brine feed close to saturation. Purification is then effected by adding sodium or other appropriate salts in the purification or refining section 46 to chemically precipitate the remaining bivalent metal ions still present in the concentrate, thus simultaneously removing these components and balancing the monovalent ion content of the thus-adjusted brine stream, and resulting in a pure brine B1a concentrated almost to the saturation point. NaOH and Na₂CO₃ may be added, but other carbonates compatible with the purification may be used. The crystallizer 48 then effects a selective NaCl crystallization to provide a solid or slurry, or both, salt product S substantially free of potassium and suitable for industrial, food processing, or chlor-alkali applications.

The second treatment section 40 may be implemented with traditional salt production techniques, such as evaporation lagoons and precipitation ponds, to further concentrate and refine the stream B1. However, the stream B1 may be concentrated by thermal equipment in the second treatment section 40. In one embodiment, the concentrator/evaporator 44 may be an evaporative brine concentrator. The brine concentrator may be a unit such as a falling film evaporator, and may operate with a vapor recompressor unit for enhanced energy efficiency and augmented water recovery. The vapor recompressor unit may compress steam that is recirculated in heat exchange contact with the entering brine stream B1 enhancing energy efficiency of the process while producing a cooled compressed (liquid) distillate stream A2 as one output stream of the second treatment section 40. A further concentrated salt stream or slurry S constitutes a second output. The distillate stream A2 may amount to 50% or more of the water present in the high TDS brine feed B1, and this may be added to or blended with the reverse osmosis permeate stream A1 from section the first treatment section 20. More generally, the distillate A2 will be of higher purity than the stream A1, so it may be maintained as a separate, distillate-quality output stream for processes such as chemical, pharmaceutical, semiconductor or other industrial applications that require ultra pure water (UPW) quality. One or more of the streams, A1, A2, etc, may have their hardness adjusted (e.g., with calcium hydroxide or other ions) to flavor or otherwise condition the stream and form a potable product.

Advantageously, the nanofiltration section 26 effectively removes sulfate and may greatly reduce the level of calcium, magnesium, bicarbonate, or other components of the original feed 22. Table I shows the concentrations of principal dissolved species in the feed and permeate streams for a representative membrane configuration of the first treatment section 20. Over about 98% of the sulfate, about 75% of the calcium, and about 85% of the magnesium are removed by nanofiltration, so that even when the nanofiltration permeate is next processed at high recovery by the reverse osmosis section 28, and the level of TDS is concentrated by a corresponding factor in the reverse osmosis stream, the concentration of these ions remains low in the reject stream. Further, the reject stream B1, although close to 100,000 ppm total solids, has a composition that may be thermally treated without incurring scaling problems in the second treatment section 40, and following further concentration, NaCl salt may be purified by relatively direct and efficient precipitation and efficiently crystallized. The nanofiltration membrane may be a membrane such as, but not limited to, the ones commonly sold for sulfate removal by The Dow Chemical Company (Midland, Mich.), GE Osmonics (Minnetonka, Minn.), and other suppliers. GE Osmonics membranes may have a particularly high sulfate rejection that is relatively independent of feed concentration. This allows use of two or more stages, and/or two or more passes, of nanofiltration to achieve recovery above about 70%, and preferably above of from about 75% to about 80%, thus maximizing the feed available to the reverse osmosis section 28 while still effectively removing over 98% of the sulfate. A multistage/multi-pass nanofiltration will provide nanofiltration recovery of about 75%.

TABLE I
WATER QUALITY

| | | | | SWRO | |
|---|---|---|---|---|---|
| | Seawater | NF Reject | NF Permeate | Permeate | Reject |
| Ca | 400 | 1,320 | 93 | 0 | 387 |
| Mg | 1,229 | 4,461 | 151 | 1 | 629 |
| Na | 10,287 | 14,960 | 8,729 | 157 | 35,874 |
| K | 368 | 536 | 313 | 6 | 1,283 |
| Cl | 18,478 | 30,920 | 14,331 | <249 | 59,016 |
| HCO₃ | 172 | 566 | 41 | 0.8 | 7 |
| SO₄ | 2,604 | 10,335 | 27 | 0.2 | 110 |
| Br | 64 | 107 | 50 | 0.9 | 204 |
| Boron | 4.2 | 4.2 | 4.2 | 1.8 | 12 |
| SiO₂ | 0.2 | 0.2 | 0.2 | 0.0 | 0.8 |
| PH | 8 | 8 | 7 | 5 | 5 |
| CO₂ | 2 | 2 | 2 | 10 | 92 |
| NaCl | 26,165 | 38,051 | 22,202 | 399 | 91,246 |
| TDS | 33,615 | 63,234 | 23,734 | 418 | 97,537 |

TABLE II
QUALITY IMPROVEMENT WITH NANOFILTRATION

| | Seawater | NF Permeate | % Change |
|---|---|---|---|
| | (% TDS) | (% TDS) | (% TDS) |
| Ca | 1.19 | 0.39 | −67.00 |
| Mg | 3.66 | 0.64 | −82.50 |
| Na | 30.60 | 36.77 | 20.10 |
| K | 1.10 | 1.32 | 20.10 |
| Cl | 54.97 | 60.36 | 9.80 |
| HCO₃ | 0.51 | 0.17 | −66.30 |
| SO₄ | 7.75 | 0.11 | −98.60 |
| Br | 0.19 | 0.21 | 9.80 |
| Organic Carbon | 0.01 | 0.00 | −71.70 |
| NaCl | 77.84 | 93.51 | 20.10 |

The reduction of scaling species in the nanofiltration permeate also allows the reverse osmosis section 28 to also be operated at high recovery and with relatively low usage of anti-scalant despite the higher pressures generally needed in, and the higher TDS concentrations generally present in, higher recovery reverse osmosis configurations having second or third stage units. For example, a three stage reverse osmosis section may be operated at a recovery of 75% on the permeate. As further shown in Table I, the levels of sodium and chloride are both somewhat reduced in the nanofiltration permeate, but these species may alternatively be somewhat augmented by appropriate selection of a seawater softening membrane having different permeation characteristics, for example wherein monovalent passage has been enhanced to decrease the overall operating pressure. Generally suitable nanofiltration membranes for use in systems according to embodiments of the present invention include, but are not limited to, SW nanofiltration membranes from The Dow Chemical Company's (Midland, Mich.) Filmtec line, DK series or SeaSoft membranes from GE Osmonics (Minnetonka, Minn.), and seawater nanofiltration membranes from Toray (Poway, Calif.).

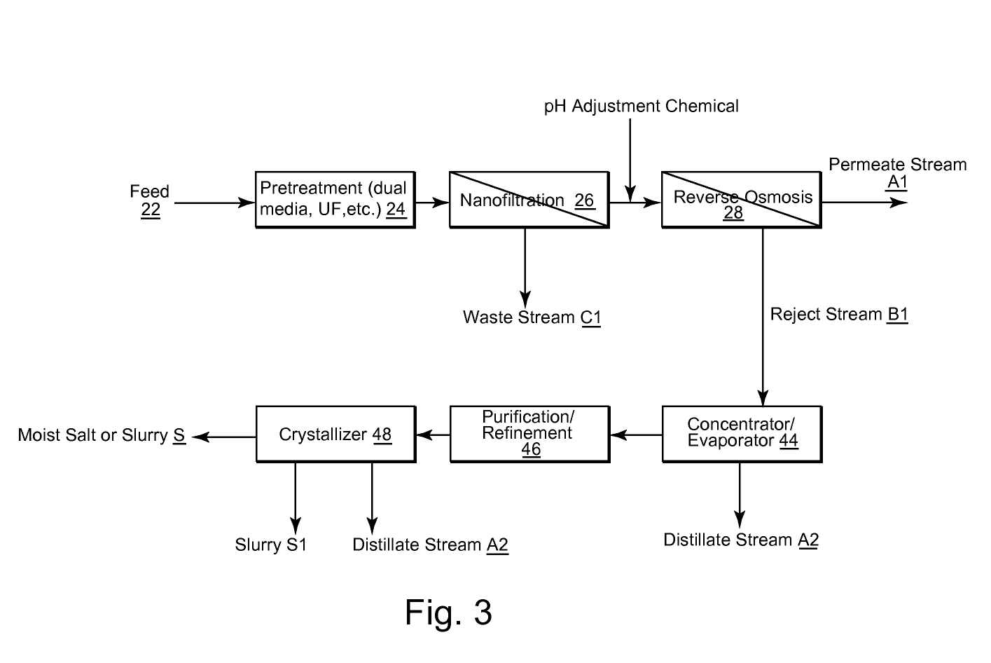

As the embodiment shows in FIG. 1, the second treatment section 40 further concentrates the brine output of the first treatment section 20 and also produces additional water. The second treatment section 40 includes an concentrator/evaporator 44, a purification or refining section 46, and a crystallizer 48, for which some representative flow volumes and operating conditions are indicated in FIG. 3. The concentrator/evaporator 44 receives the high concentration reject B1 from the reverse osmosis section 28 of the first treatment section 20 and further concentrates this stream close to the salt saturation point while recovering a substantial portion of the remaining water as distillate A2 in concentrator/evaporator 44. The further-concentrated stream may be fed to the purification or refining section 46, a purification tank where sodium salts such as sodium carbonate and sodium hydroxide are added to precipitate calcium, magnesium and other metals such as iron, thus simultaneously purifying the NaCl stream to meet high purity salt standards and balancing the monovalent ions. Thus, the purified and concentrated stream is then passed to the crystallizer 48, where the concentration may be increased above saturation and further distillate is recovered.

Advantageously, the removal of a substantial portion of the calcium and magnesium in the nanofiltration stage 26 greatly reduces the quantity of chemicals required in the purification or refining section 46 of the second treatment section 40. Calculations show that for a desalination plant producing 106,000 m³ of pure water per day or 854,000 tons per year of salt, the chemical savings are substantial. If the initial nanofiltration treatment were not provided, then the amount of NaOH and Na₂CO₃ to remove bivalent ions to avoid scaling in crystallizers and operate with a minimal purge cycle in the crystallizer would be approximately 329,411 tons/yr NaOH consumption and 92,927 tons/yr Na₂CO₃ consumption. The corresponding figures calculated for a stream treated with nanofiltration as described above are 76,769 tons/yr NaOH consumption and 11,454 tons/yr of Na₂CO₃ consumption, so that the incremental chemical savings are 252,642 tons/yr of NaOH and 81,473 tons/yr of Na₂CO₃. At a price of 0.1 $/kg for NaOH and 0.25 $/kg for Na₂CO₃ this translates into annual savings of $25.264 million for NaOH and $20.368 million for Na₂CO₃. In addition to the direct chemical savings, by arranging the system such that the purification step treats a generally lower level of bivalent impurities, the stream that passes to the crystallizer can be dependably processed with greatly decreased scaling propensity, and operated with smaller volume, less frequent purges, while assuring that the remaining impurities do not reach a concentration that would interfere with crystallization or impair purity of the salt product.

In addition, by employing the initial nanofiltration stages and/or passes to condition the feed 22 to a reverse osmosis section 28 operating at recovery substantially above conventional SWRO recovery levels, and producing a correspondingly more concentrated reject stream B1, the energy costs of thermal processing to produce salt are substantially lowered. By way of comparison, for a raw seawater feed at 35,000 TDS, a conventional SWRO plant operating at a recovery of 50% (representing a recovery on the high end) would have a reject concentration of 70,000 TDS, requiring further concentration up to 250,000 TDS in a brine concentrator/evaporator 44. One calculates the energy consumption to produce 1 ton of salt (based upon the membrane desalination section at 3.25 KWH/m³ of permeate and the evaporator section at 26.31 kWh/m³ of feed to evaporator) to be:

((100/3.5)−(100/7))*3.25+(100/7)*26.31=46.43+375.85=422.28 kWh.

Embodiments of the present invention, by contrast, would produce 40% more concentrated brine output (98,000 TDS) from the membrane desalination section at only slightly higher energy consumption due to the additional nanofiltration unit (3.75 kWh/m³), and the energy consumption would be:

((100/3.5)−(100/9.8))*3.75+(100/9.8)*26.31=68.87+268.47=337.34 kWh.

This represents an incremental energy savings per ton of salt, of 84.94 kWh.

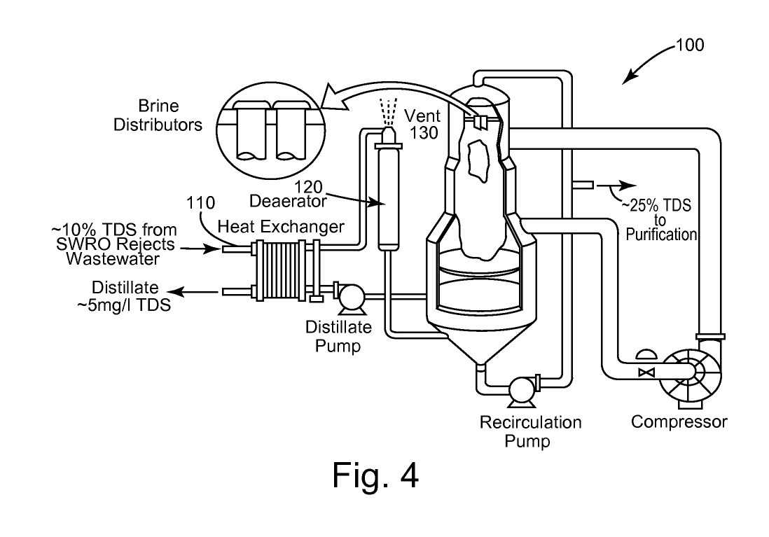

As illustrated in FIG. 4, the second treatment section 40 may include a mechanical vapor recompression apparatus 100, which collects and recompresses vapor given off as the brine is circulated through a falling film evaporator. The recompressed vapor may be placed in heat exchange contact with one or more evaporator stages, such as falling film evaporator stage as the entering SWRO reject stream (B1 in FIG. 1) is concentrated to about 250,000 ppm concentration for the final purification steps, and may also be applied to a heat exchanger 110 which raises the incoming brine stream temperature ahead of a stripper or deaerator 120. The vent 130 losses from these heating and stripping units are small, under one or two percent of the feed 22 volume, and up to about 60% of the brine feed may be recovered as recompressed vapor effectively constituting one additional high purity water output. This raises the overall water recovery by from about 18% to about 22% or more of the reverse osmosis permeate volume above the salt purification step. Purification, as noted above, includes precipitating certain remaining hardness species and rebalancing the monovalents in tank(s) of the purification or refining section 46, by applying sodium salts, thus avoiding any increase in potassium. After purification, the salt stream passes to a crystallizer 48 as previously discussed, wherein the temperature and/or pressure may be controlled to maintain a specific saturation point for pure NaCl crystallization. Periodic purges prevent build up of the potassium concentration, and maintain the levels of other impurities at sufficiently low levels to not impair either the rate of crystallization or the salt quality.

As FIGS. 1 and 4 illustrate, following purification, the high quality concentrated salt stream passes to the crystallizer 48, which may for example operate as a low-pressure evaporative concentrator, to further elevate the salt concentration and/or may also lower or otherwise control the concentrate temperature to a desired salt precipitation point so that salt may be continuously crystallized and taken off. The crystallizer 48 produces a further distillate stream, typically of lower volume than the first-mentioned distillate stream. In an overall integrated plant, one or more of the distillate streams may be processed to a higher quality by ion exchange, electrodeionization or other purification process when the site requires UPW water for sensitive applications such as semiconductor fabrication, pyrogen free water for pharmaceutical uses, high pressure steam turbine power, or other processes. Advantageously, these distillate side streams may be treated more efficiently, to a higher quality, than a typical fresh water or ground water feed containing native species, so the integrated plant offers even greater costs savings when an industrial platform has a need for such high purity water.

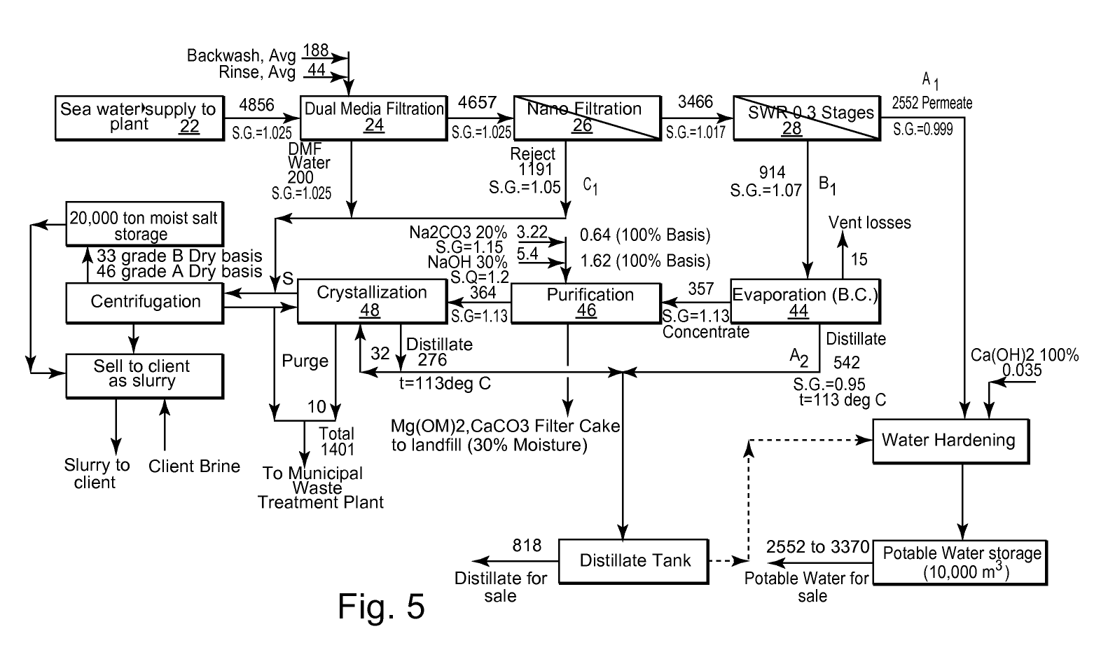

FIG. 5 illustrates another embodiment of the desalination process to achieve improved water quality by the adjustment of pH between from about 8.3 and about 10.5 after nanofiltration to achieve high removal of species that are poorly dissociated at a neutral pH but well dissociated at a higher pH. This is especially true for boron, which is often regulated to product levels of less than about 0.5 mg/L. By raising the pH above the pKa of boric acid, which is too small to be removed by reverse osmosis, the acid becomes ionized to borate and is well rejected, resulting in levels of less than about 0.5 ppm. Placement of the nanofiltration section 26 ahead of the reverse osmosis section 28 reduces scaling components such as hardness and sulfate to levels low enough to prevent scaling in the reverse osmosis section 28 run at moderate water recovery at the elevated pH's required. At higher water recovery, nanofiltration allows scaling control with the addition of small dosages of scale inhibitors. Table III shows a typical performance of this embodiment, along with the enhanced boron removal. The resultant boron level in Table III is 0.3 mg/L as compared to 1.8 mg/L in Table III. The incorporation of adjusting the pH level has a substantial economic benefit since it removes the requirement for additional stages of treatment that are specifically for boron and other similar undissociated species removal.

TABLE III
WATER QUALITY

| | | | NF | pH Adjusted | SWRO | SWRO |
|---|---|---|---|---|---|---|
| | Seawater | NF Reject | Permeate | SWRO Feed | Permeate | Reject |
| | (mg/l) | (mg/l) | (mg/l) | (mg/l) | (mg/l) | (mg/l) |
| Ca | 400 | 1,320 | 93 | 93 | 0 | 387 |
| Mg | 1,229 | 4,461 | 151 | 151 | 1 | 628 |
| Na | 10,287 | 14,960 | 8,729 | 8,730 | 157 | 35,976 |
| K | 368 | 536 | 313 | 313 | 6 | 1,287 |
| Cl | 18,478 | 30,920 | 14,331 | 14,331 | 249 | 59,083 |
| HCO₃ | 172 | 566 | 41 | 42 | 0.8 | 173 |
| SO₄ | 2,604 | 10,335 | 27 | 27 | 0.2 | 114 |
| Br | 64 | 107 | 50 | 50 | 0.9 | 206 |
| Boron | 4.2 | 4.2 | 4.3 | 4.3 | 0.3 | 17.0 |
| SiO₂ | 0.2 | 0.2 | 0.2 | 0.2 | 0.0 | 0.9 |
| pH | 8 | 8 | 7 | 9.2 | 8.5 | 9.9 |
| CO₂ | 2 | 2 | 2 | 0 | 0 | 0 |
| NaCl | 26,165 | 38,051 | 22,202 | 22,205 | 399 | 91,505 |
| TDS | 33,615 | 63,234 | 23,743 | 23,745 | 417 | 97,882 |

In another embodiment of the present invention, a water desalination system 10 is disclosed, which comprises an intake section of a size to supply and pretreat a defined flow of a seawater or brackish feed 22 containing sulfate for a system having a pure water output capacity, a nanofiltration process that is configured to filter a defined flow to produce nanofiltration permeate at recovery above from about 70% to about 80% having sulfate concentration reduced at least about 90%, and a reverse osmosis process which receives the nanofiltration permeate as a feed and operates to produce reverse osmosis permeate stream A1 at a recovery above from about 70% to about 80% and a concentrated reverse osmosis reject stream B1 suitable for enhanced commercial NaCl production. As a result, the reverse osmosis permeate A1 amounts to from about 49% to about 64% of the defined flow of the feed and the intake section may be sized less than twice the pure water output capacity. The reverse osmosis reject stream B1 may be provided to a concentrator/evaporator 44 to concentrate the stream to saturation and crystallization, and concentrator/evaporator 44 may recover one or more additional streams of pure water such that between from about 75% to about 95% of the nanofiltration permeate is recovered as pure water. The nanofiltration section 26 may remove a substantial portion of bivalent metal ions present in the feed such that the reverse osmosis reject is non-scaling in the concentrator/evaporator 44 and salt is more economically purified by chemical precipitation of contaminants prior to crystallization. In another embodiment, the system is comprised of multiple nanofiltration stages and/or multiple nanofiltration passes, to achieve recovery above about 70%, the permeate of the nanofiltration is fed to a multistage reverse osmosis section 28 to achieve high water recovery while producing a selectively salt-enriched reject having a TDS of about 100,000 and suitable for salt manufacture.

While the embodiments of the present invention have been described, various changes or substitutions may be made to these embodiments by those ordinarily skilled in the art pertinent to the present invention without departing from the technical scope of the present invention. Therefore, the technical scope of embodiments of the present invention encompasses not only those embodiments described above, but also all that fall within the scope of the appended claims.

This written description uses examples to disclose the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal languages of the claims.

What is claimed is:

1. A desalination plant for treating a sea water or brackish water feed wherein the desalination plant comprises:
a first treatment section to effectively remove scaling species, the first treatment section comprising nanofiltration section, the nanofiltration section comprising at least two stages and at least two passes; and
a reverse osmosis section that operates at high recovery to produce a purified permeate stream and a selectively NaCl salt-enriched reject stream as a saline output.

2. The desalination plant of claim 1, wherein the selectively NaCl salt-enriched reject stream is concentrated to above about 85,000 ppm total dissolved solids.

3. The desalination plant of claim 1, wherein the desalination plant comprises an intake stream of saline feed that is less than two times the size of the permeate stream produced from the reverse osmosis section.

4. The desalination plant of claim 1, wherein the first treatment section produces the purified permeate stream via membrane pressure filtration processes at recovery above about 55% and removes a preponderance of species that contaminate salt production.

5. The desalination plant of claim 4, wherein the pressure membrane filtration processes include nanofiltration softening that effectively removes substantially all sulfates.

6. The desalination plant of claim 1 wherein bivalent ions are substantially removed from the nanofiltration permeate and the first treatment section operates a recovery level above about 65% to form an monovalent salt enhanced permeate stream for concentration.

7. The desalination plant of claim 1 further comprising a second treatment section configured to concentrate and refine the selectively NaCl salt-enriched reject stream, wherein the second treatment section concentrates the selectively NaCl salt-enriched reject stream by a thermal or hybrid section and produces pure water and a purified salt product.

8. The desalination plant of claim 7, wherein the plant operates above about 62% water recovery.

9. The desalination plant of claim 7, wherein overall recovery is above from about 65% to about 70%

10. The desalination plant of claim 7, wherein the second treatment section further concentrates the selectively NaCl salt-enriched reject stream, and chemically precipitates unwanted impurities from the selectively NaCl salt-enriched reject stream and forms a refined concentrate stream, such that salt may be continuously recovered by crystallization at purity above about 99% as a high purity salt product.

11. The desalination plant of claim 10, wherein the second treatment section further comprises a crystallizer for forming a salt solid or slurry from said refined concentrate stream.

12. The desalination plant of claim 11, wherein periodic or continuous blowdown from the crystallizer is used to limit the impurities from the crystallized product.

13. The desalination plant of claim 7, wherein the second treatment section removes residual impurities by chemical precipitation to produce a refined salt concentrate, and pure salt is separated at a temperature or further concentration effective to crystallize salt from a saturated solution.

14. The desalination plant of claim 7, wherein the refined salt concentrate from the reject stream forms a moist salt or slurry that is centrifugally extracted from a crystallizer seed loop and a crystal seed stream is returned from a centrifuge to a crystallizer liquor to drive crystallization for continuous take-off of a concentrated salt product.

15. The desalination plant of claim 7 wherein the second treatment section comprises a mechanical vapor compressor that produces additional pure water and further concentrates the selectively NaCl salt-enriched reject stream.

16. A desalination plant for treating a seawater or brackish feed comprised of a nanofiltration section and a reverse osmosis section, the nanofiltration section comprising at least two stages and at least two passes, wherein the nanofiltration section is arranged to form a nanofiltration permeate substantially diminished in scaling and fouling components, and wherein the nanofiltration permeate is fed to the reverse osmosis section.

17. The desalination plant of claim 16, wherein the reverse osmosis section is operated at high recovery to form a purified water permeate stream and a non-scaling salt reject stream concentrated above about 85,000 ppm total dissolved solids.

18. The desalination plant of claim 16, wherein the nanofiltration permeate is fed to the reverse osmosis section at an elevated pH to form a purified water permeate stream having less than about 0.5 ppm boron.

19. The desalination plant of claim 18, wherein the pH of the nanofiltration permeate is raised before being fed to the reverse osmosis section, wherein the reverse osmosis section operates at a recovery of about 70% while producing a high recovery purified water permeate stream.

20. The desalination plant of claim 18, wherein the nanofiltration section provides scaling control when small dosages of scale inhibitors or anti-scalant are added.

21. The desalination plant of claim 18, wherein the pH elevation is from about 8.3 to about 10.5.

22. A water desalination system comprising:
an intake section of a size to supply and pretreat a defined flow of a seawater or brackish feed containing sulfate for a system having a pure water output capacity;
a nanofiltration section configured to filter the defined flow to produce nanofiltration permeate at recovery above from about 70% to about 80% and configured to reduce sulfate concentration at least about 90%, the nanofiltration section comprising at least two stages and at least two passes; and
a reverse osmosis section which receives the nanofiltration permeate as a feed and operates to produce a reverse osmosis permeate stream at a recovery above from about 70% to about 80% and a concentrated reverse osmosis reject stream suitable for enhanced commercial NaCl production, whereby the reverse osmosis permeate amounts to from about 49% to about 64% of the defined flow of the feed and the intake section is sized less than twice the pure water output capacity.

23. The water desalination system of claim 22, wherein the reverse osmosis reject stream is provided to a thermal concentrator to concentrate the reverse osmosis reject stream to saturation and crystallization, wherein the thermal concentrator recovers one or more additional streams of pure water such that between from about 75% to about 95% of the nanofiltration permeate is recovered as pure water.

24. The desalination system of claim 23, wherein a second treatment section purifies and then crystallizes salt, maintaining low impurities in the crystallizer by periodic purge to remove interfering contaminants not removed by the nanofiltration section.

25. The water desalination system of claim 22, wherein the nanofiltration section removes a substantial portion of bivalent metal ions present in the feed such that the reverse osmosis reject stream is non-scaling in the concentrator and salt is more economically purified by chemical precipitation of contaminants prior to crystallization.

26. The desalination system claim 22, wherein the reverse osmosis section comprises a multistage reverse osmosis section to which the nanofiltration permeate is fed, wherein the multistage reverse osmosis section achieves high water recovery while producing a selectively salt-enriched reject having a total dissolved solids of about 100,000 and suitable for salt manufacture.
